(19) United States
(12) Patent Application Publication
(10) Pub. No.: US 2012/0207379 A1
(43) Pub. Date: Aug. 16, 2012

(54) Image Inspection Apparatus, Image Inspection Method, And Computer Program

(75) Inventors: Masato Shimodaira, Osaka (JP); Naoya Uchiyama, Osaka (JP)

(73) Assignee: KEYENCE CORPORATION, Osaka (JP)

(21) Appl. No.: 13/352,408

(22) Filed: Jan. 18, 2012

(30) Foreign Application Priority Data
Feb. 10, 2011 (JP) 2011-027853

(51) Int. Cl. G06K 9/00

(52) U.S. Cl. 382/141

(57) ABSTRACT

The present invention provides an image inspection apparatus and a method which remove noise even when there is a change in brightness of a multi-valued image, and which inspect a defect, and relates to a computer program. A multi-valued image is acquired, and a reference intensity value based on intensity information for the image is calculated. A difference for each pixel between the intensity value and the reference intensity value is calculated, and a threshold value to track and change in response to a change in the reference intensity value is set and stored. Pixels that have a calculated difference that is larger than the threshold value is extracted, and an aggregate body of pixels based on a connectivity of the intensity value of the extracted pixels is specified, and a characteristic amount using the difference is calculated. A defect is discriminated based on the calculated characteristic amount.

### CROSS-REFERENCE TO RELATED APPLICATIONS

The present application claims foreign priority based on Japanese Patent Application No. 2011-027853, filed Feb. 10, 2011, the contents of which is incorporated herein by reference.

### BACKGROUND OF THE INVENTION

1. Field of the Invention

The present invention relates to an image inspection apparatus and an image inspection method which effectively remove noise as a non-detection object even when a change in the peripheral environment or the like causes a change in the brightness and darkness of a multi-valued image acquired by capture of an image in an inspection object region, and which inspect the presence or absence, the size, or the shape of a defect such as a scratch or dirt in a blob form (aggregate body) as a detection object, and also relates to a computer program capable of executing each processing process of the image inspection method.

2. Description of Related Art

An image data processing apparatus described as a conventional example has been proposed in which acquired multi-valued image data is binarized using a threshold value, and image data after binarization is subjected to labeling processing to thereby remove noise in the form of a labeling-processed figure that does not satisfy a predetermined pixel number. Consequently when the figure has a small surface area, even noise that has a high intensity value can be removed (for example, reference is made to Japanese Patent Application Laid-Open No. 06-083953). Hereinafter, an object that will ultimately be the object of inspection is termed a detection object, and an object to be removed as noise is termed a non-detection object.

However, in Japanese Patent Application Laid-Open No. 06-083953, although a non-detection object having an area smaller than that of the detection object can be deleted, a non-detection object having an area larger than that of the detection object cannot be removed. A non-detection object having the area larger than that of the detection object can be removed by varying the threshold value for execution of binarization to be higher (or lower) than the maximum intensity value. However, when a portion in the detection object has a intensity value that is lower (or higher) than the non-detection object, there is the problem that the figure of the detection object is finely segmented and it is not possible to acquire the correct characteristics of the detection object. Consequently, there is the possibility that discrimination from a non-detection object having a small surface area may not be enabled by fine segmentation of the figure.

In Japanese Patent Application Laid-Open No. 06-083953, when the detection object is a figure having a small surface area and a plurality of such figures is present in a predetermined region, all such figures are removed as noise. In other words, a figure being a plurality of detection objects cannot be detected in the form of a single figure.

Furthermore, Japanese Patent Application Laid-Open No. 2009-186434 sets minimum intensity values to be detected in an image of a detection object as a first threshold value, specifies the aggregate body (blob) of all pixels including the non-detection objects and detection objects that have a intensity value that is greater than the first threshold value, sets a second threshold value to be larger than the first threshold value, and removes an aggregate body of pixels, formed only from intensity values that are smaller than a second threshold value, from the aggregate body of all specified pixels. In this manner, a blob, formed from only intensity values that are smaller than the second threshold value and having a large surface area as a non-detection object, can be accurately deleted as noise from a multi-valued image, and thereby detection of a blob as a detection object is enabled without segmentation even when a portion having a low intensity value is present in the blob that is the detection object.

### CITATION LIST

### Patent Literature

[Patent Literature 1] Japanese Patent Application Laid-Open No. 06-083953

[Patent Literature 2] Japanese Patent Application Laid-Open No. 2009-186434

### SUMMARY OF THE INVENTION

However, Japanese Patent Application Laid-Open No. 2009-186434 entails the problem that fluctuations in brightness cannot be tracked when there is a change in brightness and darkness in the multi-valued image acquired by imaging of the inspection object region, and there is a possibility that correct characteristics cannot be acquired in relation to the detection object.

The present invention has been made in view of the above problems, and an object thereof is to provide an image inspection apparatus and an image inspection method which effectively remove noise as a non-detection object even when there is a change in the brightness and darkness of a multi-valued image acquired by capture of an image in an inspection object region as a result of a change in the peripheral environment, or the like, and that inspect the presence or absence, the size, or the shape of a defect such as a scratch or dirt in a blob form (aggregate body) as a detection object, and that relates to a computer program capable of executing each processing process of the image inspection method.

In order to achieve the above object, an image inspection apparatus according to a first aspect of the present invention has a configuration including an imaging device for acquiring a multi-valued image of an inspection object region, a reference intensity value calculating device for calculating a reference intensity value based on intensity information for the acquired multi-valued image, a difference calculating device for calculating a difference for each pixel between the intensity value for each pixel of the multi-valued image and the calculated reference intensity value, a threshold value storing device for setting and storing a threshold value relative to the reference intensity value to track and change in response to a change in the reference intensity value, a labeling device for extracting a plurality of pixels that have a calculated difference that is larger than the threshold value, and for specifying an aggregate body of pixels based on the connectivity of the intensity value of the plurality of extracted pixels, a characteristic amount calculating device for calculating a characteristic amount using the difference in relation to an aggregate body of pixels specified by the labeling device, and a defect discriminating device for discriminating a defect in a specified aggregate body of pixels based on the calculated characteristic amount.

It is preferred that the image inspection apparatus according to a second aspect of the invention includes the first aspect, and includes a calculation method selection accepting device for accepting selection of one method from a plurality of methods for calculating the reference intensity value.

It is preferred that the image inspection apparatus according to a third aspect of the invention includes the first aspect or the second aspect, and the reference intensity value calculating device calculates the reference intensity value in the form of an average value or median value for a intensity value that is intensity information for the multi-valued image of the inspection object region.

It is preferred that the image inspection apparatus according to a fourth aspect of the invention includes any one of the first aspect to the third aspect, and the difference calculating device calculates the difference as a positive or negative value, the threshold value storing device is adapted to store a value that is selectively set as any of a positive threshold value, negative threshold value, or both values, and the labeling device specifies an aggregate body of pixels based on any of only the positive threshold value, only the negative threshold value, or both the positive threshold value and the negative threshold value.

It is preferred that the image inspection apparatus according to a fifth aspect of the invention includes the fourth aspect, and the threshold value is set separately as the positive threshold value and the negative threshold value.

It is preferred that the image inspection apparatus according to a sixth aspect of the invention includes any one of the first aspect to the fifth aspect, and further includes a segment setting device for setting a segment of a predetermined size in relation to the multi-valued image acquired by the imaging device, and the reference intensity value calculating device calculates a reference intensity value based on intensity information for the segment image acquired from the set segment, and the difference calculating device calculates the difference for each pixel of the unit segment.

It is preferred that the image inspection apparatus according to a seventh aspect of the invention includes the sixth aspect, and the segment setting device includes an input accepting device for accepting an input of a displacement amount in the X direction or the Y direction of the segment, and the size of the segment.

It is preferred that the image inspection apparatus according to an eighth aspect of the invention includes any one of the first aspect to the seventh aspect, and further includes a colored image displaying device for displaying an image assigned with color with reference to the difference.

It is preferred that the image inspection apparatus according to a ninth aspect of the invention includes any one of the first aspect to the eighth aspect, and further includes a histogram displaying device for quantitative displaying of the threshold value in a histogram for the difference.

It is preferred that the image inspection apparatus according to a tenth aspect of the invention includes any one of the first to the ninth aspect, and the characteristic amount is at least one of sign information related to the sign of the difference, a total of the difference, a maximum value of the difference, an average value of the difference, or a reference deviation of the difference.

It is preferred that the image inspection apparatus according to a eleventh aspect of the invention includes any one of the first to the tenth aspect, and the characteristic amount calculating device is adapted to calculate the characteristic amount in the form of two or more of any of sign information related to the sign of the difference, a total of the difference, a maximum value of the difference, an average value of the difference, or a reference deviation of the difference, and the defect discriminating device is adapted to discriminate a defect in the aggregate body of pixels based on a discrimination reference value combining two or more of the calculated characteristic amounts.

It is preferred that the image inspection apparatus according to a twelfth aspect of the invention includes any one of the first to the eleventh aspect, and the defect discriminating device is adapted to discriminate a defect in the aggregate body of pixels based on a discrimination reference value that combines the characteristic amount and the surface area of the specified aggregate body of pixels.

In order to achieve the above object, an image inspection method according to a thirteenth aspect of the invention has a configuration including an imaging process for acquiring a multi-valued image of an inspection object region, a reference intensity value calculating process for calculating a reference intensity value based on intensity information for the acquired multi-valued image, a difference calculating process for calculating a difference for each pixel between the intensity value for each pixel of the multi-valued image and the calculated reference intensity value, a threshold value storing process for setting and storing a threshold value relative to the reference intensity value to track and change in response to a change in the reference intensity value, a labeling process for extracting a plurality of pixels that have a calculated difference that is larger than the threshold value, and for specifying an aggregate body of pixels based on the connectivity of the intensity value of the plurality of extracted pixels, a characteristic amount calculating process for calculating a characteristic amount using the difference in relation to an aggregate body of pixels specified in the labeling process, and a defect discriminating process for discriminating a defect in a specified aggregate body of pixels based on the calculated characteristic amount.

In order to achieve the above object, a computer program according to a fourteenth aspect of the invention has a configuration to cause a computer to execute imaging processing for acquiring an image of a multi-valued image of an inspection object region, reference intensity value calculating processing for calculating a reference intensity value based on intensity information for the acquired multi-valued image, difference calculating processing for calculating a difference for each pixel between the intensity value for each pixel of the multi-valued image and the calculated reference intensity value, threshold value storing processing for setting and storing a threshold value relative to the reference intensity value to track and change in response to a change in the reference intensity value, labeling processing for extracting a plurality of pixels that have a calculated difference that is larger than the threshold value, and specifying an aggregate body of pixels based on the connectivity of the intensity value of the plurality of extracted pixels, characteristic amount calculating processing for calculating a characteristic amount using the difference in relation to an aggregate body of pixels specified in the labeling process, and defect discriminating processing for discriminating a defect in a specified aggregate body of pixels based on the calculated characteristic amount.

In the first aspect , the thirteenth aspect, and the fourteenth aspect of the invention, a reference intensity value is calculated based on intensity information for the acquired multi-valued image, a difference is calculated for each pixel between the intensity value for each pixel of the multi-valued image and the calculated reference intensity value, and a threshold value is set and stored relative to the reference intensity value to track and change in response to a change in the reference intensity value. A plurality of pixels that have a calculated difference that is larger than the threshold value is extracted, an aggregate body of pixels is specified based on the connectivity of the intensity value of the plurality of extracted pixels, a characteristic amount is calculated in relation to an aggregate body of pixels using the difference of the reference intensity value and the intensity value for each pixel in the multi-valued image, and thereby a defect in a specified aggregate body of pixels is discriminated. In this manner, even when the brightness and darkness of the acquired multi-valued image changes, since a reference intensity value can be calculated to track the fluctuation in brightness, highly accurate detection of a defect is enabled. Furthermore, simple processing is enabled since it is sufficient if one threshold value is stored. In addition, since the characteristic amount using a difference between the intensity value for each pixel in the multi-valued image and the reference intensity value is calculated, the accuracy of image inspection is further enhanced.

In the second aspect of the invention, an optimal calculation method can be selected in response to the characteristics of the defect present in the detection object by accepting selection of one method from a plurality of methods for calculating the reference intensity value.

In the third aspect of the invention, the reference intensity value can be calculated with higher accuracy by calculation of the reference intensity value in the form of an average value or median value for intensity value that is intensity information for the multi-valued image of the inspection object region.

In the fourth aspect of the invention, the difference between the intensity value for each pixel of the multi-valued image and the reference intensity value is calculated as a positive or negative value, a value is stored that is selectively set as any of a positive threshold value, a negative threshold value, or both values, an aggregate body of pixels is specified based on any of only a positive threshold value, only a negative threshold value, or both a positive threshold value and a negative threshold value, and thereby selection of use of any of a positive threshold value (brightness side), a negative threshold value (darkness side), or both a positive threshold value and a negative threshold value (both darkness and brightness sides) is enabled to specify a blob. Therefore, specification of a blob to be detected by a user can be ensured in response to the distribution state for the intensity values.

In the fifth aspect of the invention, the threshold value can be separately set as a reference value even when the determination reference value is different for the brightness/darkness of the multi-valued image by separate setting of the threshold value as a positive threshold value and a negative threshold value.

In the sixth aspect of the invention, a segment of a predetermined size is set in relation to a multi-valued image acquired by the imaging device, a reference intensity value is calculated based on intensity information for the segment image acquired from the set segment, and the difference is calculated for each pixel of the unit segment. In this manner, specification of the detection object as a single blob can be facilitated, and the speed and stability of calculation processing can be enhanced.

In the seventh aspect of the invention, an object to be specified as a single blob can be simply adjusted by accepting an input of a displacement amount in the X direction or the Y direction of the segment and the size of the segment.

In the eighth aspect of the invention, visual confirmation of the distribution state of the difference is enabled by displaying an image assigned with color with reference to the difference of the reference intensity value and the intensity value of the multi-valued image.

In the ninth aspect of the invention, the threshold value can be simply adjusted by visual confirmation by quantitative display of the threshold value in a histogram for the difference between the reference intensity value and the intensity value for each pixel in the multi-valued image.

In the tenth aspect of the invention, the accuracy of detecting a defect can be further enhanced since the characteristic amount is at least one of sign information related to the sign of the difference between the reference intensity value and the intensity value for each pixel in the multi-valued image, a total of the difference between the reference intensity value and the intensity value for each pixel in the multi-valued image, a maximum value of the difference between the reference intensity value and the intensity value for each pixel in the multi-valued image, an average value of the difference, or a reference deviation of the difference between the reference intensity value and the intensity value for each pixel in the multi-valued image.

In the eleventh aspect of the invention, the accuracy of detecting a defect can be further enhanced since the characteristic amount is calculated in the form of two or more of any of sign information related to the sign of the difference between the reference intensity value and the intensity value for each pixel in the multi-valued image, a total of the difference between the reference intensity value and the intensity value for each pixel in the multi-valued image, a maximum value of the difference between the reference intensity value and the intensity value for each pixel in the multi-valued image, an average value of the difference, or a reference deviation of the difference between the reference intensity value and the intensity value for each pixel in the multi-valued image, and a defect in the aggregate body of pixels is discriminated based on a discrimination reference value combining two or more of the calculated characteristic amounts.

In the twelfth aspect of the invention, the accuracy of detecting a defect can be further enhanced since a defect in the aggregate body of pixels is discriminated based on a discrimination reference value that combines the characteristic amount and the surface area of the aggregate body of specified pixels.

According to the present invention, a reference intensity value is calculated based on intensity information for the acquired multi-valued image, a difference is calculated between the intensity value for each pixel of the multi-valued image and the calculated reference intensity value, and a threshold value relative to the reference intensity value is set and stored to track and change in response to a change in the reference intensity value. A plurality of pixels that have a calculated difference that is larger than the threshold value is extracted, and an aggregate body of pixels is specified based on the connectivity of the intensity value of the plurality of extracted pixels, a characteristic amount is calculated using the difference between the reference intensity value and the intensity value for each pixel in the multi-valued image in relation to an aggregate body of pixels specified in the labeling process, and a defect in a specified aggregate body of pixels is discriminated. In this manner, even when there has been a change in the brightness/darkness in the acquired multi-valued image, calculation of the reference intensity value is enabled by tracking the fluctuations in the brightness, and therefore high accuracy detection of a defect is enabled. Furthermore, simple processing is enabled since it is sufficient if one threshold value is stored. In addition, since the characteristic amount using a difference between the intensity value for each pixel in the multi-valued image and the reference intensity value is calculated, the accuracy of image inspection is further enhanced.

### BRIEF DESCRIPTION OF THE DRAWINGS

FIG. 1 is a block diagram illustrating an example of a schematic configuration of an image inspection apparatus according to a first embodiment of the present invention;

FIG. 2 is a flowchart illustrating the setting processing steps for an image inspection method using the image inspection apparatus according to the first embodiment of the present invention;

FIGS. 3 (a) and (b) illustrate an example of a difference image of a correlative display of the calculated difference;

FIGS. 4A and 4B illustrate an example of a threshold value setting screen including a histogram for the difference and a labeling processed image using both the brightness threshold value and the darkness threshold value;

FIGS. 5A and 5B illustrates an example of a threshold value setting screen including a histogram for the difference and a labeling processed image using only the brightness threshold value;

FIGS. 6A and 6B illustrates an example of a threshold value setting screen including a histogram for the difference and a labeling processed image when both the brightness threshold value and the darkness threshold value are used with separate settings;

FIG. 7 is a flowchart illustrating the setting processing steps for a defect discrimination process and an image inspection method using the image inspection apparatus according to the first embodiment;

FIG. 8 is a block diagram illustrating an example of a schematic configuration of an image inspection apparatus according to a second embodiment of the present invention;

FIG. 9 is a flowchart illustrating the setting steps for set data in an image inspection method using the image inspection apparatus according to the second embodiment;

FIGS. 10 (a)-(c) illustrate an example of a labeling processed image using a segment image;

FIGS. 11 (a)-(c) illustrate an example of a labeling processed image using a segment image based on a character image;

FIG. 12 is a flowchart illustrating the setting steps in a defect discrimination process of an image inspection method using the image inspection apparatus according to the second embodiment.

### DESCRIPTION OF THE PREFERRED EMBODIMENTS

The embodiments of the present invention will be described in detail below with reference to the drawings. Those elements that have the same or similar configuration or function are denoted by the same or similar reference numerals in the figures referred to in the description of each embodiment, and such description will not be repeated.

### Embodiment 1

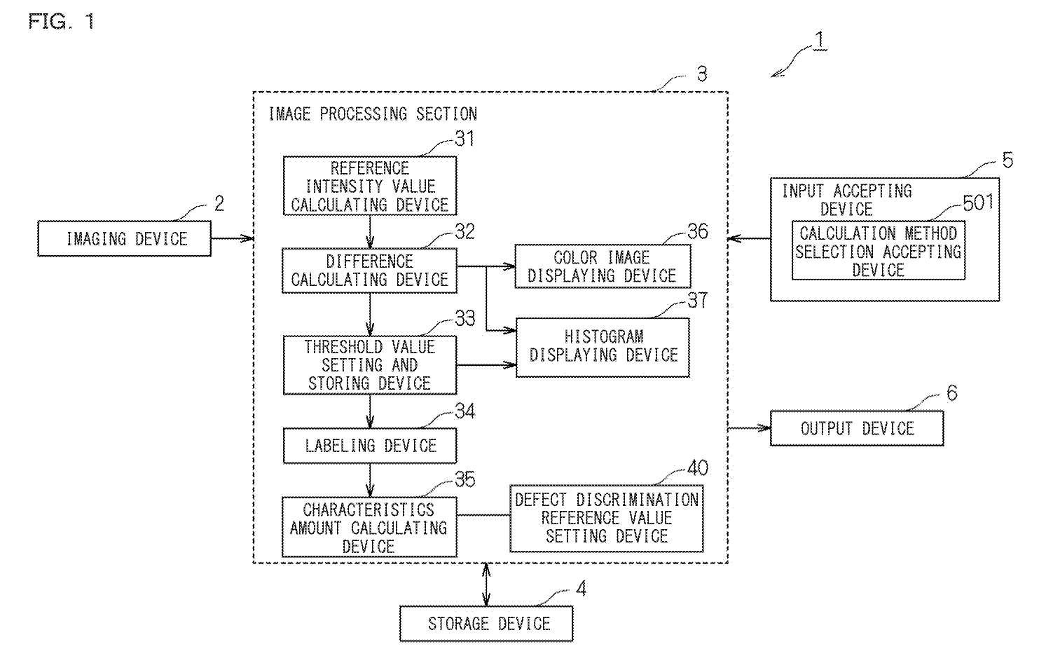

FIG. 1 is a block diagram illustrating an example of a schematic configuration of an image inspection apparatus according to a first embodiment of the present invention. As shown in FIG. 1, the image inspection apparatus 1 according to the first embodiment is configured from an imaging device 2, an image processing section 3, a storage device 4, an input accepting device 5, and an output device 6.

For example, the imaging device 2 functions as a two-dimensional CCD camera, and for example, captures an image of a work (inspection object region) on a film to acquire a multi-valued image for output to the image processing section 3.

The image processing section 3 includes a reference intensity value calculating device 31, a difference calculating device 32, a threshold value setting and storing device (threshold value storing device) 33, a labeling device 34, a characteristic amount calculating device 35, a color image displaying device 36, a histogram displaying device 37, and a defect discrimination reference value setting device 40. Furthermore, the image processing section 3 is configured from a CPU, a ROM, a RAM, an external I/F, and the like, and controls processing operations of the reference intensity value calculating device 31, the difference calculating device 32, the threshold value setting and storing device 33, the labeling device 34, the characteristic amount calculating device 35, the color image displaying device 36, the histogram displaying device 37, and the defect discrimination reference value setting device 40.

The reference intensity value calculating device 31 calculates a reference intensity value based on intensity information for a multi-valued image acquired by the imaging device 2. In contrast to a conventional configuration, the reference intensity value is calculated for each acquired multi-valued image, a suitable reference intensity value can be calculated even when there has been a change in the brightness/darkness of the image acquired by the imaging device 2.

There is no particular limitation in relation to the method for calculating of the reference intensity value, and for example, an average value or median value for the intensity value that is intensity information for the multi-valued image of the work (inspection object region) is calculated as the reference intensity value. Of course, the reference intensity value may be calculated using a different method, or a designation may be accepted from a user. The selection of calculation by a given method may be accepted by the calculation method selection accepting device 51 of the input accepting device 5.

The difference calculating device 32 calculates a difference for each pixel from the calculated reference intensity value and a intensity value for each pixel of the multi-valued image. Since the reference intensity value is calculated for each acquired multi-valued image, the calculated difference exhibits a substantially equal deviation in relation to both positive and negative values.

The threshold value setting and storing device 33 sets and stores a threshold value for labeling processing based on the difference calculated by the difference calculating device 32. The threshold value is preferably set separately as a positive threshold value (brightness) and a negative threshold value (darkness). This is due to the fact that even when there is a difference in the determination reference value for brightness/darkness, a threshold value to act as a reference value can be set separately.

The labeling device 34 extracts a plurality of pixels having intensity values, in which the calculated difference is larger than the threshold value, from the multi-valued image acquired by the imaging device 2, executes a labeling process to specify an aggregate body (hereinafter referred to as a blob) of pixels based upon connectivity of the intensity values of the extracted plurality of pixels, and outputs the labeling processed image.

The characteristic amount calculating device 35 calculates a characteristic amount using the difference between the reference intensity value and the intensity value for each pixel of the multi-valued image in relation to the blob that is specified by the labeling device 34. The calculated characteristic amount is, for example, sign information related to the sign of the difference, a total of the difference, a maximum value of the difference, an average value of the difference, or a reference deviation of the difference. The calculated characteristic amount is used as a determination reference value to thereby enable determination of whether or not the specified blob is a defect.

The defect discrimination reference value setting device 40 sets a discrimination reference value in accordance with a user operation for use in discrimination of the defect in the specified blob. The discrimination reference value is set based on the calculated characteristic amount. The characteristic amount using the difference is calculated for each blob, and the discrimination reference value is set based on the calculated characteristic amount. Therefore discrimination is enabled in relation to a defect that cannot be discriminated only by reference to the surface area of the specified blob.

The storage device 4 functions as an image memory and stores, as needed, a multi-valued image captured by the imaging device 2, and a labeling processed image obtained by the labeling device 34. The input accepting device 5 accepts input of a threshold value from the user, and input of selection of the calculation method for the reference intensity value. The output device 6 functions as an image display apparatus, and displays a multi-valued image, a labeling processed image, and the like on the screen. Furthermore, a color image colored in accordance by the difference from the reference intensity value, a histogram showing the difference distribution, and the like are displayed on the screen.

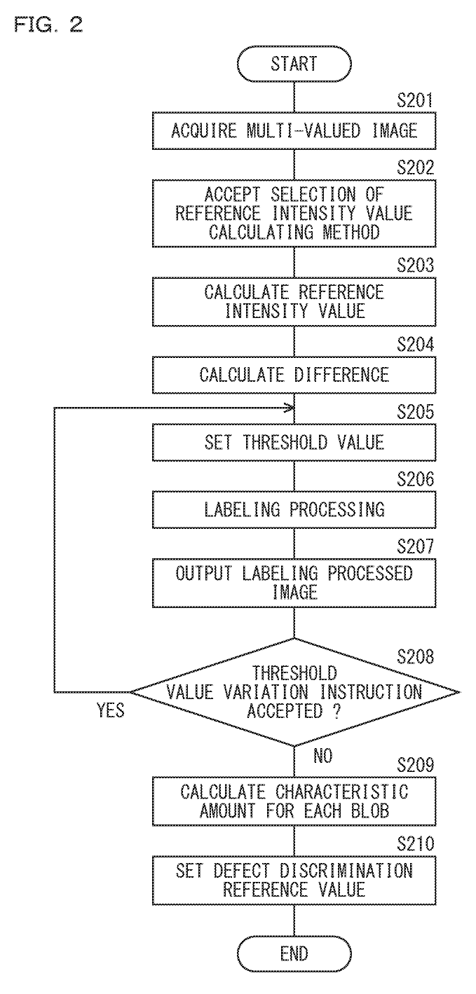

FIG. 2 is a flowchart illustrating the setting processing steps for an image inspection method using the image inspection apparatus 1 according to the first embodiment. Each setting process of the image inspection method according to the present invention is executed in accordance with a computer program according to the invention that is stored in an inner portion of the image processing section 3.

In FIG. 2, firstly, the image processing section 3 acquires a multi-valued image of an inspection object region from the image device 2 (step S201). Next, the image processing section 3 accepts and stores a selection of a calculation method for calculation of the reference intensity value (step S202). More specifically, a selection is accepted of whether to calculate an average value of the intensity value that is intensity information for the multi-valued image of the work (inspection object region), whether to calculate a median value of the intensity value, or whether to accept an instruction from the user.

When the ratio of the surface area of the background portion in the acquired multi-valued image is at least half, the median value for the intensity value that is intensity information for the multi-valued image of the work (inspection object region) can be calculated as a stabilized value without effect from the intensity value that express a defect. Conversely, when the ratio of the surface area of the background portion in the acquired multi-valued image is no more than half, there is a possibility that the intensity value expressing a defect will be calculated as a reference intensity value.

The average value for the intensity value that is intensity information for the multi-valued image of the work (inspection object region) avoids a phenomenon in which the reference intensity value is inverted such as when using a median value, and therefore inhibits extreme fluctuations. On the other hand, the intensity value that indicates that a defect may exhibit a tendency to be affected by an increase in the proportion of the surface area in the defect portion in the acquired multi-valued image, and therefore the calculated reference intensity value may not be stable. Therefore, the reference intensity value can be calculated with higher accuracy by selection of an optimal calculation method in response to conditions such as the proportion of the surface area in the background portion in the acquired multi-valued image, the proportion of the surface area occupied by the defect portion, or the like. The calculation of the reference intensity value is not limited to a median value of the intensity value and the average value of the intensity value, and for example, options for selection include the mode of the histogram, or the like.

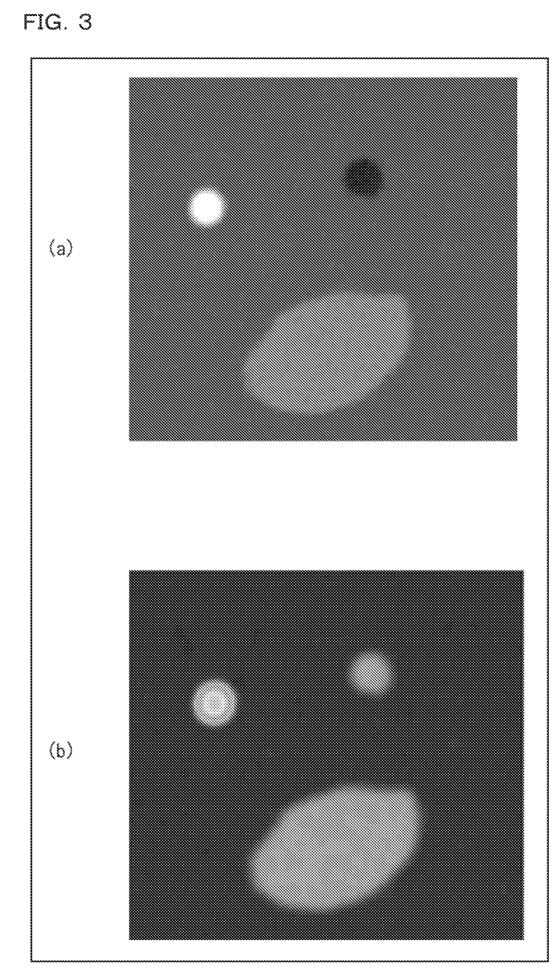

Next, the image processing section 3 calculates a reference intensity value using a calculation method for which selection has been accepted (step S203). The difference for each pixel between the intensity value for each pixel of the multi-valued image and the calculated reference intensity value is calculated (step S204). FIG. 3 illustrates an example of a difference image of a correlative display of the calculated difference. FIG. 3(a) illustrates an example of the original multi-valued image acquired by the imaging device 2. FIG. 3(b) illustrates a difference image based on the multi-valued image illustrated in FIG. 3(a).

In the examples illustrated in FIG. 3, the reference intensity value is taken as median value of the intensity value that is the intensity information of the multi-valued image of the work (inspection object region). The difference is calculated as an absolute value between 0-255. Although not immediately evident from FIG. 3(b), respective display may be executed with a color close to blue as the value approaches 0, a color close to red as the value approaches 255, and a color close to green as the value approaches 128 which represents a middle value. More specifically, a color image related to the difference is generated by the color image displaying device 36 and is displayed on the screen using the output device 6. In this manner, visual confirmation is enabled in relation to the distribution condition of the difference.

Returning now to FIG. 2, the image processing section 3 sets the threshold value in response to the distribution condition of the difference (step S205). The image processing section 3 executes a labeling process using the set threshold value (step S206), and outputs the resulting labeling processed image (step S207).

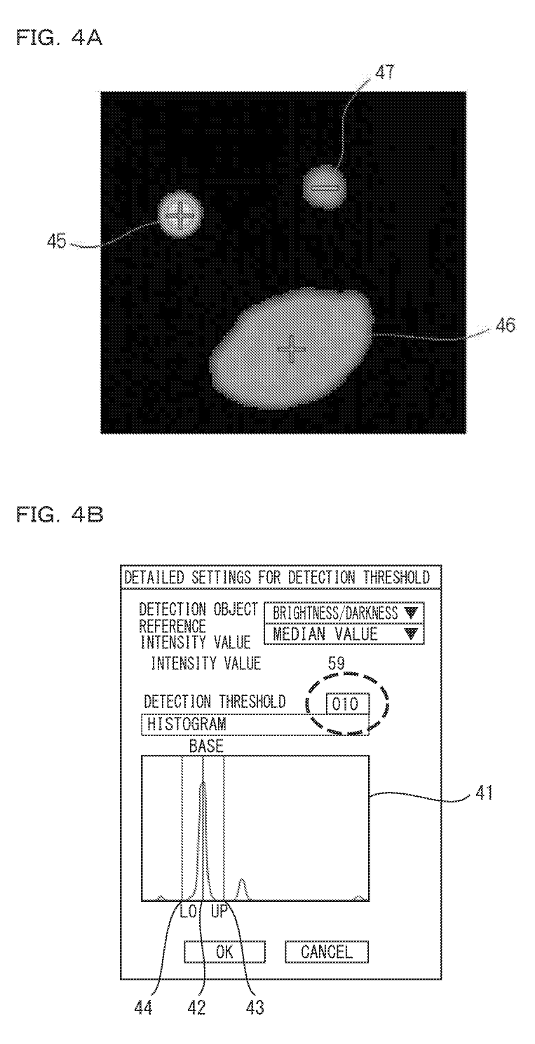

FIG. 4 to FIG. 6 illustrate an example of a threshold value setting screen including a histogram for the difference and a labeling processed image. FIG. 4 to FIG. 6 illustrate a defect detected using the brightness threshold value as “+” and a defect detected using the darkness threshold value as “−”.

FIG. 4 illustrates an example of a threshold value setting screen including a histogram for the difference and a labeling processed image when both the brightness threshold value and the darkness threshold value are used. FIG. 4(a) illustrates the labeling processed image and FIG. 4(b) illustrates the threshold value setting screen including the difference histogram.

The threshold value setting screen in FIG. 4(b) illustrates selection of “brightness/darkness” exhibiting use of the threshold value for both brightness and darkness as a “detection object”, and selection of a “median value” exhibiting the calculation of a median value for the intensity value as a “reference intensity value”. That is to say, selection of a method of calculating the reference intensity value on the threshold value setting screen is accepted (calculation method selection accepting device 51).

In the example illustrated in FIG. 4, ‘10’ is set as the “detection threshold value”. This setting is for the purpose of detecting and displaying the aggregate body of pixels that have a intensity value that is outside a range of 10 on the bright side and 10 on the dark side about the reference intensity value. The horizontal axis of the histogram 41 shows the intensity value, and the vertical axis shows the frequency. The reference intensity value 42 is displayed quantitatively on the histogram 41 as a median value. In this manner, since the threshold value is set as a relative value to the reference intensity value 42, the threshold value also varies by tracking variations in the reference intensity value 42.

Since ‘10’ is set as the “detection threshold value”, a first threshold value 43 of a high intensity value as 10 on the brightness side (+ side) and a second threshold value 44 of a low intensity value as 10 on the darkness side (− side) about the reference value 42 is quantitatively displayed on the histogram 41 (histogram displaying device 37). Pixels having a intensity value outside a range that is not less than the second threshold value 44 and no more than the first threshold value 43 due to labeling processing are extracted, and an aggregate body of pixels is specified as a blob based on the connectivity of the intensity value of the extracted pixels to thereby generate the labeling processed image illustrated in FIG. 4(a).

The blob 45, 46 is a blob that is specified by the first threshold value 43 that is the brightness threshold value in the labeling processed image illustrated in FIG. 4(a). That is to say, specification is performed in relation to an aggregate body of pixels that have a intensity value that is greater than the first threshold value 43. Furthermore the blob 47 is a blob that is specified by the second threshold value 44 that is the dark side threshold value. In other words, specification is performed in relation to an aggregate body of pixels that have a intensity value that is smaller than the second threshold value 44. Since the difference is calculated as an absolute value, an aggregate body of pixels for which the calculated difference is greater than the difference between the reference intensity value 42 and the second threshold value 44 is specified. Adjustment of the object to be specified as a blob is enabled by varying the value of the “detection threshold value”.

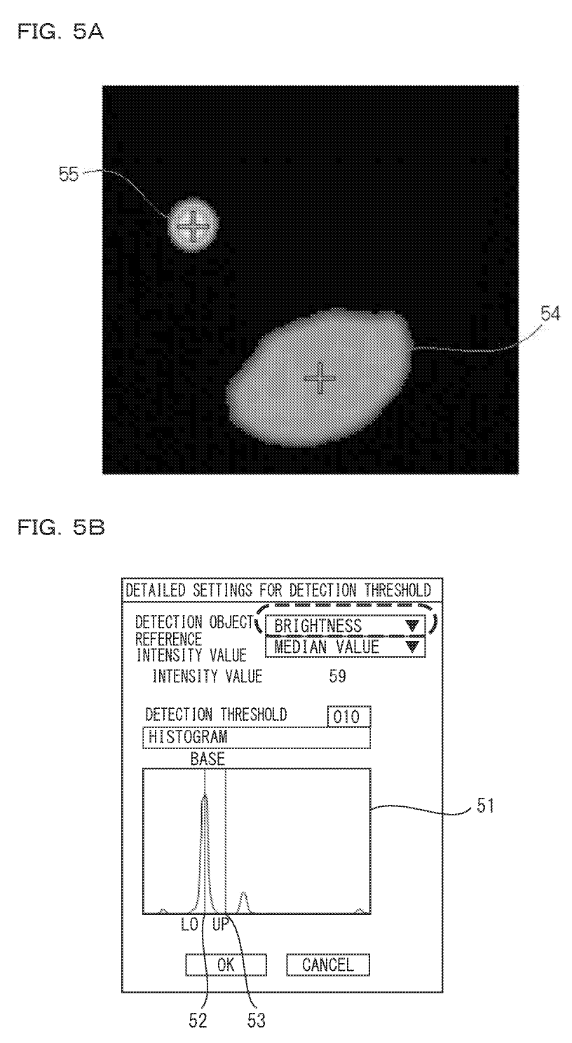

FIG. 5 illustrates an example of a threshold value setting screen including a histogram for the difference and a labeling processed image using only the brightness threshold value. FIG. 5(a) illustrates the labeling processed image and FIG. 5(b) illustrates the threshold value setting screen including the histogram of differences.

The threshold value setting screen in FIG. 5(b) illustrates selection of “brightness” exhibiting use of only the threshold value for brightness as a “detection object”, and selection of a “median value” exhibiting the calculation of a median value for the intensity value as a “reference intensity value”. In the same manner as in FIG. 4, ‘10’ is set as the “detection threshold value”. This setting is for the purpose of detecting and displaying the aggregate body of pixels that have a intensity value that is outside a range of 10 on the bright side from the reference intensity value. The horizontal axis of the histogram 51 shows the intensity value, and the vertical axis shows the frequency. The reference intensity value 52 is displayed quantitatively on the histogram 51 as a median value.

Since ‘10’ is set as the “detection threshold value”, only a threshold value 53 of a high intensity value of 10 on the brightness side (+ side) from the reference intensity value 52 is quantitatively displayed on the histogram 51 (histogram displaying device 37). An aggregate body of pixels is set as a blob based on extraction of pixels having a intensity value in a range that is greater than the threshold value 53 due to labeling processing, and connectivity of the intensity value of the extracted pixel to thereby generate the labeling processed image illustrated in FIG. 5(a). In FIG. 5(a), the dark side (the range of intensity values that is smaller than the reference intensity value 52) is not subjected to labeling processing and is entirely displayed in black.

The blob 54, 55 is a blob that is specified by the brightness threshold value 53 that is the brightness threshold value in the labeling processed image illustrated in FIG. 5(a), and therefore enables detection of only brightness defects. Of course, it is obviously possible to select “darkness” that indicates use of only the darkness threshold value as the “detection object” and execute labeling processing to thereby detect only defects on the dark side.

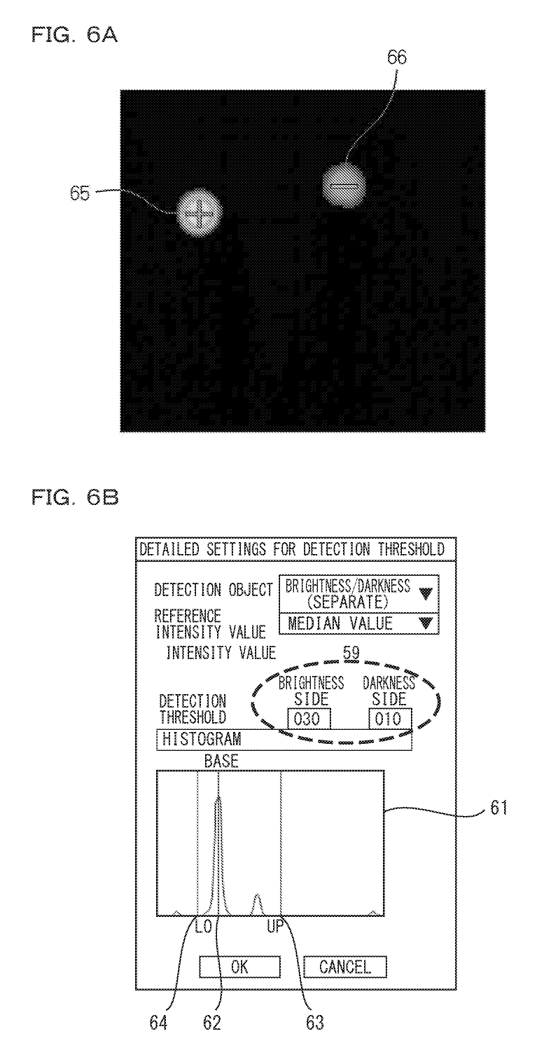

FIG. 6 illustrates an example of a threshold value setting screen including a histogram for the difference and a labeling processed image when both the brightness threshold value and the darkness threshold value are used with separate settings. FIG. 6(a) illustrates the labeling processed image and FIG. 6(b) illustrates the threshold value setting screen including the histogram of differences.

In the example illustrated in FIG. 6, “brightness/darkness (separate)” indicating use of separate threshold values for both brightness and darkness as a “detection object” is selected, and a “median value” indicating calculation of a median value of a intensity value as a “reference intensity value” is selected. Although ‘30’ is set on the “bright side” and ‘10’ is set on the “dark side” as a “detection threshold value”, this setting is for the purpose of displaying the aggregate body of pixels that have a intensity value that is outside a range of 30 on the bright side and 10 on the dark side about the reference intensity value. The horizontal axis of the histogram 61 shows the intensity value, and the vertical axis shows the frequency. The reference intensity value 62 is displayed quantitatively on the histogram 61 as a median value.

Since ‘30’ on the “bright side” and ‘10’ on the “dark side” are set as the “detection threshold value”, a first threshold value 63 of a high intensity value of 30 on the brightness side (+ side) and a second threshold value 64 of a low intensity value of 10 on the darkness side (− side) about the reference intensity value 62 are quantitatively displayed on the histogram 61 (histogram displaying device 37). An aggregate body of pixels is specified as a blob based on extraction of pixels having a intensity value outside a range that is not less than the second threshold value 64 and no more than the first threshold value 63 due to labeling processing, and the connectivity with the intensity value of the extracted pixel to thereby generate the labeling processed image illustrated in FIG. 6(a).

The blob 65 is a blob that is specified by the first threshold value 63 that is the brightness threshold value in the labeling processed image illustrated in FIG. 6(a). That is to say, specification is performed in relation to an aggregate body of pixels that have a intensity value that is greater than the first threshold value 63. Furthermore, the blob 66 is a blob that is specified by the second threshold value 44 that is the dark side threshold value. In other words, specification is performed in relation to an aggregate body of pixels that have a intensity value that is smaller than the second threshold value 64. Since the difference is calculated as an absolute value, the calculated difference specifies an aggregate body of pixels that is greater than the difference between the reference intensity value 62 and the second threshold value 64. Adjustment of the object to be specified as a blob is enabled by varying the value of the “detection threshold value” separately in relation to brightness and darkness.

The user checks the labeling processed image displayed on the screen and determines whether or not to change the threshold value. More specifically, the user performs a determination based on whether or not all the blobs (defects) that are the detection objects on the screen are displayed or not.

Returning to FIG. 2, the image processing section 3 determines whether or not the variation instruction for the threshold value has been accepted (step S208), and when the image processing section 3 determines that the variation instruction for the threshold value has been accepted (step S208: YES), the image processing section 3 returns the processing to step S205, and repeats the processing steps described above. When the image processing section 3 determines that the variation instruction for the threshold value has not been accepted (step S208: NO), the image processing section 3 calculates the characteristic amount for each specified blob (step S209). The calculated characteristic amount is sign information related to the sign of the difference from the reference intensity value, a total of the difference from the reference intensity value, a maximum value of the difference, an average value of the difference from the reference intensity value, or a reference deviation of the difference from the reference intensity value.

Then, the image processing section 3 sets the discrimination reference value used in defect discrimination of specified blobs according to a user operation (step S210). The discrimination reference value is set according to the calculated specification amount. The characteristic amount using a difference is calculated for each blob and the discrimination reference value is set based on the calculated characteristic amount to thereby enable discrimination of a defect that cannot be discrimination only with reference to the surface area of the specified blob. For example, there is a range of extremely detailed requirements in relation to detection as a defect, such as (1) when the surface area of the specified blob is small, and the difference from the reference intensity value is small, detection as a defect should be avoided, (2) when the surface area of the specified blob is small, and the difference from the reference intensity value is large, detection as a defect should be performed, or (3) when the surface area of the specified blob is large, and the difference from the reference intensity value is small, detection as a defect should be performed.

Detection of details defects is enabled by use as a determination instruction of the feature of whether or not the characteristic amount described above is a defect. For example, determination of a defect as a blob in which the total difference from the reference intensity value is larger than a predetermined value enables (1) no detection as a defect when the surface area of the specified blob is small, and the difference from the reference intensity value is small, (2) detection as a defect when the surface area of the specified blob is small, and the difference from the reference intensity value is large, and (3) detection as a defect since the total is large when the surface area of the specified blob is large, and the difference from the reference intensity value is small. Furthermore, since the characteristic amount is obtained by use of a difference from the reference intensity value, even when there is a change in the brightness/darkness, there is little change in the difference information, and determination can be performed with high accuracy using a stable characteristic amount.

When a plurality of characteristic amounts is calculated as a characteristic amount for example from sign information related to the sign of the difference from the reference intensity value, a total of the difference from the reference intensity value, a maximum value of the difference from the reference intensity value, an average value of the difference from the reference intensity value, or a reference deviation of the difference from the reference intensity value, these values may be combined to thereby enable setting of a complex defect discrimination reference value. Furthermore, a defect discrimination reference value that is a combination of the characteristic amount and the surface area of the specified blob can be set.

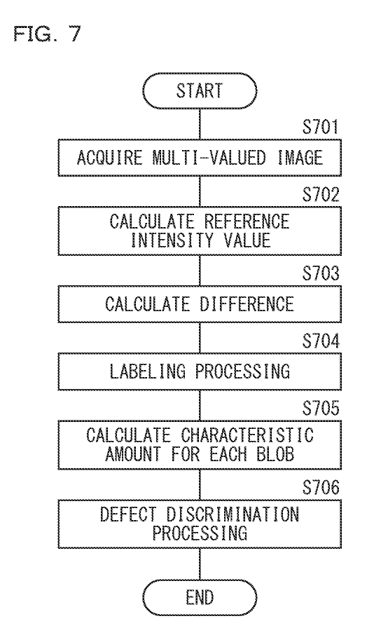

Whether or not an object is a blob can be specified based on a threshold value that is set and stored as described above, and it can be discriminated based on the discrimination reference value whether or not an object is a defect. FIG. 7 is a flowchart illustrating the steps for defect discrimination processing in the image inspection method used in the image inspection apparatus 1 according to the first embodiment. Each defect discrimination processing step of the image inspection method according to the present invention is executed in accordance with a computer program according to the present invention that is stored in an inner portion of the image processing section 3.

In FIG. 7, firstly, the image processing section 3 acquires a multi-valued image of an inspection object region from the image device 2 (step S701). Next, the image processing section 3 calculates a reference intensity value using the stored calculation method (step S702). A difference for each pixel between the intensity value for each pixel of the multi-valued image is calculated (step S703). Next, the image processing section 3 executes a labeling process using the set and stored threshold value (step S704).

The image processing section 3 calculates a characteristic amount for each specified blob (step S705). The calculated characteristic amount is, for example, sign information related to the sign of the difference, a total of the difference, a maximum value of the difference, an average value of the difference, or a reference deviation of the difference. The image processing section 3 executes defect discrimination processing based on the discrimination reference value used in the defect discrimination for the specified blob (step S706).

According to the first embodiment as described above, a blob is specified based on extracting a plurality of pixels that have a calculated difference that is larger than the threshold value, and the connectivity of the intensity value with the plurality of extracted pixels, and then calculating a characteristic amount using the difference from the reference intensity value in relation the specified blob to thereby enable calculation of a reference intensity value that tracks a fluctuation in brightness even when the brightness/darkness of the acquired multi-valued image changes. Therefore, detection of a defect is enabled with high accuracy. Furthermore, since the characteristic amount using a difference from the reference intensity value is calculated, the accuracy of defect detection is further enhanced.

### Second Embodiment

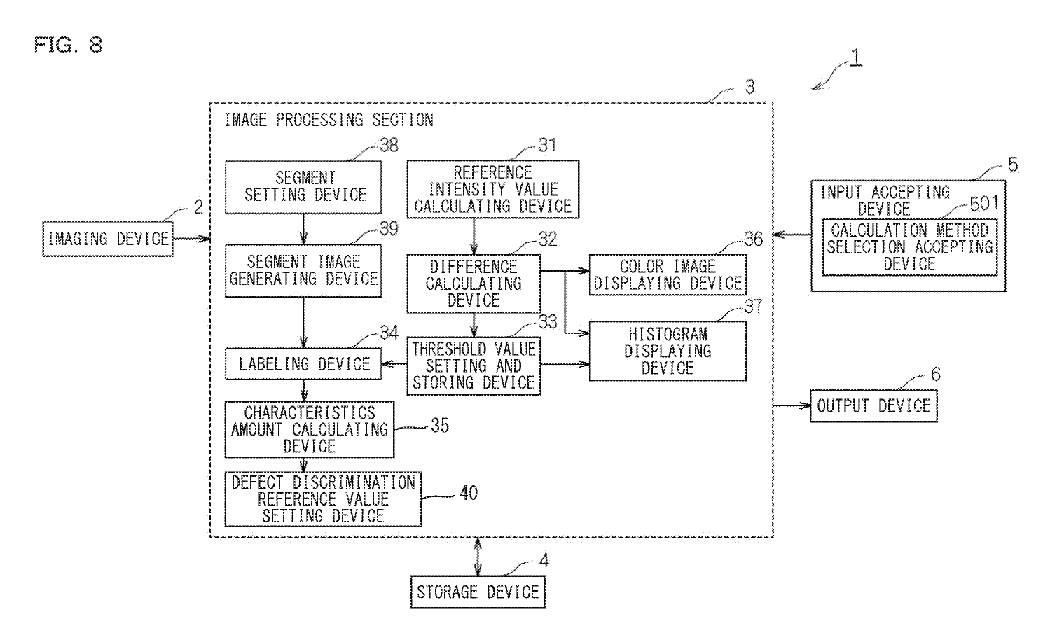

FIG. 8 is a block diagram illustrating an example of a schematic configuration of an image inspection apparatus according to a second embodiment of the present invention. In FIG. 8, the image inspection apparatus 1 according to the second embodiment is configured from the imaging device 2, the image processing section 3, the storage device 4, the input accepting device 5, and the output device 6.

The difference of the second embodiment from the first embodiment is that a segment setting device 38 and a segment image generating device 39 are added to the image processing device 3 according to the first embodiment, and the input accepting device 5 accepts input of a segment size and a displacement amount in addition to the selection of the calculating method of the threshold value and the reference intensity value. The following description will focus on those points of difference.

The segment setting device 38 sets and stores a segment in the segment image generating device 39. The segment has a size (pixel number in X direction and pixel number in Y direction) required by a user that has been accepted by the input accepting device 5 in relation to the multi-valued image acquired by the imaging device 2.

The segment image generating device 39 calculates an average intensity value for pixels in a segment while displacing the segment of the size set and stored by the segment setting device 38 at a pixel unit (displacement amount in the X direction or the Y direction) required by a user, to thereby generate a segment image that has the calculated average intensity value. In the following processing, one segment is handled as one pixel. Since the segment image is outputted to the image display apparatus represented by the output device 6 and displayed on screen, a user can adjust the segment size and displacement amount while checking the segment image. The adjusted segment size and displacement amount are stored in the storage device 4.

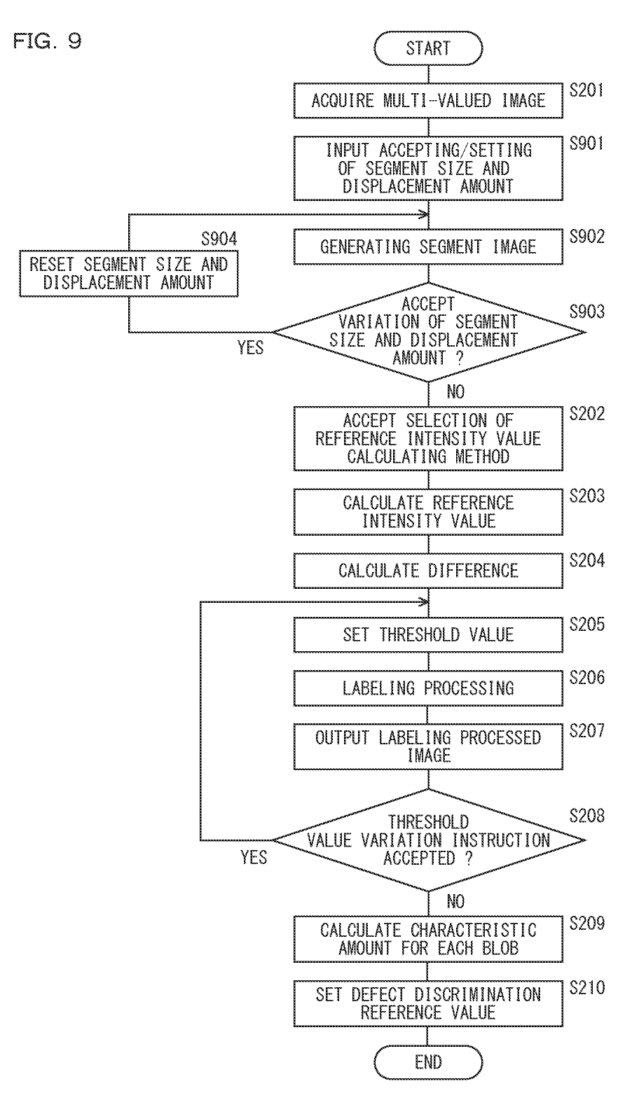

FIG. 9 is a flowchart illustrating the setting steps for set data in an image inspection method using the image inspection apparatus 1 according to the second embodiment. Each processing step in the image inspection method according to the second embodiment is executed in accordance with a computer program according to the present invention that is stored in an inner portion of the image processing section 3.

In FIG. 9, firstly, the image processing section 3 acquires a multi-valued image of an inspection object region using the image device 2 (step S201). Next, the image processing section 3 sets and stores an input segment size and displacement amount in the segment image generating device 39 for which input has been accepted from a user for the segment size and displacement amount (step S901).

The image processing section 3 calculates an average intensity value for the pixels in a segment while displacing the stored segment size with the stored displacement amount, and thereby generates a segment image that has the calculated average intensity value (step S902).

The image processing section 3 determines whether or not a change to the segment size with the displacement amount from the user has been accepted (step S903). When the image processing section 3 determines that a change to the segment size with the displacement amount from the user has been accepted (step S903: YES), the image processing section 3 resets the segment size with the displacement amount (step S904), the processing is returned to step S902 and the processing steps described above are repeated.

When the image processing section 3 determines that a change to the segment size with the displacement amount from the user has not been accepted (step S903: NO), the image processing section 3 accepts and stores the selection of the calculation method for calculation of the reference intensity value (step S202). More specifically, a selection is accepted and stored in relation to calculate an average value for the intensity value that is intensity information for the segment image of the work (inspection object region), or to calculate a median value for the intensity value, or to accept an instruction from a user.

The image processing section 3 calculates a reference intensity value using a calculation method for which selection has been accepted (step S203). The difference for each pixel between the intensity value for each pixel of the multi-valued image and the calculated reference intensity value is calculated (step S204). The image processing section 3 sets the threshold value in response to the distribution condition of the difference (step S205). The image processing section 3 executes a labeling process using the set threshold value (step S206), and outputs the resulting labeling processed image (step S207).

The image processing section 3 determines whether or not the variation instruction for the threshold value has been accepted (step S208), and when the image processing section 3 determines that the variation instruction for the threshold value has been accepted (step S208: YES), the image processing section 3 returns the processing to step S205, and repeats the processing steps described above. When the image processing section 3 determines that the variation instruction for the threshold value has not been accepted (step S208: NO), the image processing section 3 calculates the characteristic amount for each specified blob (step S209). The calculated characteristic amount is sign information related to the sign of the difference, a total of the difference, a maximum value of the difference, an average value of the difference, or a reference deviation of the difference.

Then, the image processing section 3 sets the discrimination reference value used in defect discrimination of specified blobs according to a user operation (step S210). The discrimination reference value is set based on the calculated characteristic amount. A characteristic amount is calculated for each blob using the difference, and a discrimination reference value is set based on the calculated characteristic amount to thereby enable discrimination of a defect that cannot be discriminated only with reference to the surface area of the specified blob.

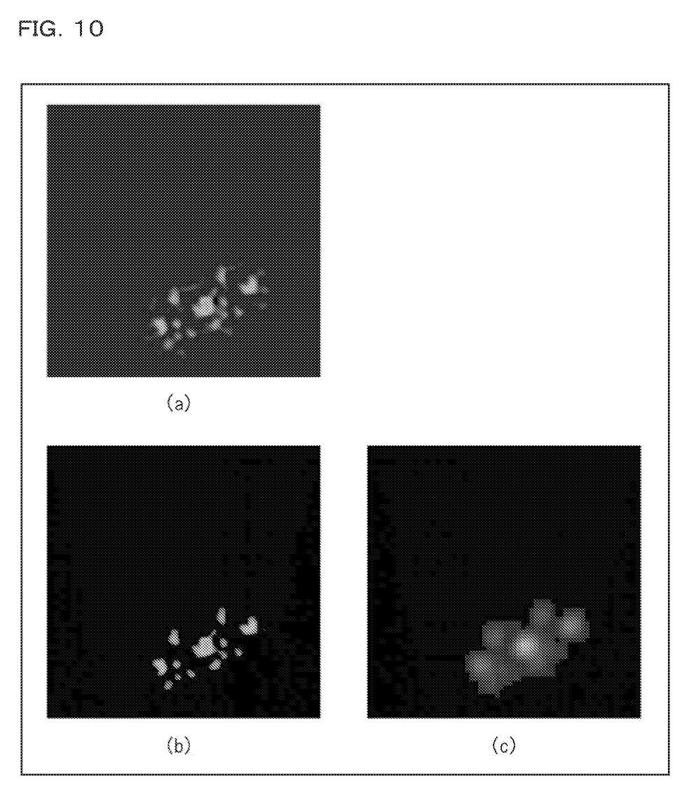

FIG. 10 illustrates an example of a labeling processed image using a segment image. FIG. 10(a) illustrates the original multi-valued image acquired by the imaging device 2. FIG. 10(b) illustrates the labeling processed image generated without segmenting based on the multi-valued image illustrated in FIG. 10(a). FIG. 10(c) illustrates the labeling processed image generated with segmenting based on the multi-valued image illustrated in FIG. 10(a).

As illustrated in FIG. 10(b), when the labeling processed image is generated without segmenting, in the same manner as the original multi-valued image, since the defect is detected in a segmented state, the defect cannot be detected as a single blob. In this context, as illustrated in FIG. 10(c), when the labeling processed image is generated after segmenting, since the defect can be detected as a single blob, the characteristic amount of the defect can be calculated as the characteristic amount of the blob, and determination with enhanced accuracy is possible of whether or not the specified blob is a defect. Furthermore, since each segment can be processed as one pixel, the corresponding data amount is reduced and calculation processing is enabled at a higher processing speed than when segmenting is not performed.

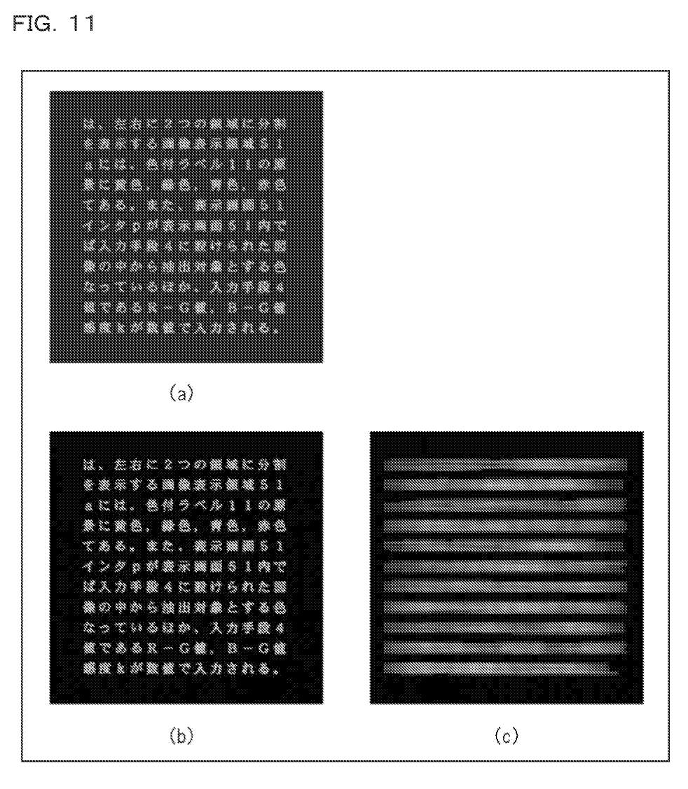

FIG. 11 illustrates an example of a labeling processed image using a segment image based on a character image. FIG. 11(a) illustrates the original multi-valued image acquired by the imaging device 2. FIG. 11(b) illustrates the labeling processed image generated without segmenting based on the multi-valued image illustrated in FIG. 11(a). FIG. 11(c) illustrates the labeling processed image generated with segmenting based on the multi-valued image illustrated in FIG. 11(a).

As illustrated in FIG. 11(b), when the labeling processed image is generated without segmenting, in the same manner as the original multi-valued image, separate detection is enabled of respective characters. In this context, as illustrated in FIG. 11(c), when the labeling processed image is generated after segmenting in a horizontal direction, detection is enabled of respective lines as a blob rather than individual characters. Therefore, the scope of application can be enlarged by use of counting of a line number or the like.

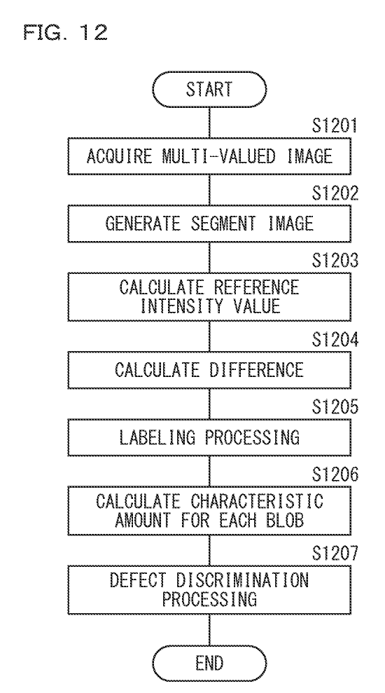

Whether or not an object is a blob can be specified based on a threshold value that is set and stored as described above, and it can be discriminated based on the discrimination reference value whether or not an object is a defect. FIG. 12 is a flowchart illustrating the steps for defect discrimination processing in the image inspection method used in the image inspection apparatus 1 according to the second embodiment. Each defect discrimination processing step of the image inspection method according to the present invention is executed in accordance with a computer program according to the present invention that is stored in an inner portion of the image processing section 3.

In FIG. 12, firstly, the image processing section 3 acquires a multi-valued image of an inspection object region using the image device 2 (step S1201). Next, the image processing section 3 calculates an average intensity value in a segment while displaying the segment of the stored size at the stored displacement amount to thereby generate a segment image that has the calculated average intensity value (step S1202).

The image processing section 3 calculates a reference intensity value using the stored calculation method (step S1203), and calculates the difference for each pixel in each segment unit between the reference intensity value and the intensity value for each pixel in the multi-valued image (step S1204). The image processing section 3 executes labeling processing using the set threshold value (step S1205).

The image processing section 3 calculates a characteristic amount for each specified blob (step S1206). The calculated characteristic amount is, for example, sign information related to the sign of the difference, a total of the difference, a maximum value of the difference, an average value of the difference, or a reference deviation of the difference. The image processing section 3 executes a defect discrimination process based on the discrimination reference value used in defect discrimination of the specified blob (step S1207).

According to the second embodiment, a segment image is generated by using an average intensity value in the calculated segment as one pixel while displacing a segment of a size required by the user by a required pixel unit (displacement amount). Then the reference intensity value is calculated based on the intensity information of the generated segment image, and a difference from the calculated reference intensity is calculated for each pixel in the segment. In this manner, specification of the detection object as a single blob is facilitated, and the calculation and stability of calculation processing can be enhanced.

The present invention is not limited to the above embodiments, and various modifications and variations may be added within the scope of the spirit of the present invention.

### EXPLANATION OF THE REFERENCE NUMERALS

Image Inspection Apparatus
Imaging Device
Image Processing Section
Storage Device
Input Accepting Device
Output Device
Reference Intensity Value Calculating Device
Difference Calculating Device
Threshold Value Setting and Storing Device (Threshold Value Storing Device)
Labeling Device
Characteristic Amount Calculating Device
Color Image Displaying Device
Histogram Setting Device
Segment Setting Device
Segment Image Generating Device
Defect Discrimination Reference Value Setting Device
Calculation Method Selection Accepting Device

What is claimed is:

1. An image inspection apparatus comprising:
an imaging device for acquiring a multi-valued image of an inspection object region;
a reference intensity value calculating device for calculating a reference intensity value based on intensity information for the acquired multi-valued image;
a difference calculating device for calculating a difference for each pixel between the intensity value for each pixel of the multi-valued image and the calculated reference intensity value;
a threshold value storing device for setting and storing a threshold value relative to the reference intensity value to track and change in response to a change in the reference intensity value;
a labeling device for extracting a plurality of pixels that have a calculated difference that is larger than the threshold value, and specifying an aggregate body of pixels based on the connectivity of the intensity value of the plurality of extracted pixels;
a characteristic amount calculating device for calculating a characteristic amount using the difference in relation to an aggregate body of pixels specified by the labeling device; and
a defect discriminating device for discriminating a defect in a specified aggregate body of pixels based on the calculated characteristic amount.

2. The image inspection apparatus according to claim 1, further comprising:
a calculation method selection accepting device for accepting selection of one method from a plurality of methods for calculating the reference intensity value.

3. The image inspection apparatus according to claim 1, wherein
the reference intensity value calculating device calculates the reference intensity value in the form of an average value or median value for a intensity value that is intensity information for the multi-valued image of the inspection object region.

4. The image inspection apparatus according to claim 1, wherein
the difference calculating device calculates the difference as a positive or negative value;
the threshold value storing device is adapted to store a value that is selectively set as any of a positive threshold value, negative threshold value, or both values; and
the labeling device specifies an aggregate body of pixels based on any of only the positive threshold value, only the negative threshold value, or both the positive threshold value and the negative threshold value.

5. The image inspection apparatus according to claim 4, wherein
the threshold value is set separately as the positive threshold value and the negative threshold value.

6. The image inspection apparatus according to claim 1, further comprising:
a segment setting device for setting a segment of a predetermined size in relation to the multi-valued image acquired by the imaging device;
the reference intensity value calculating device calculates a reference intensity value based on intensity information for the segment image acquired from the set segment; and
the difference calculating device calculates the difference for each pixel of the unit segment.

7. The image inspection apparatus according to claim 6, wherein
the segment setting device includes an input accepting device for accepting an input of a displacement amount in the X direction or the Y direction of the segment, and the size of the segment.

8. The image inspection apparatus according to claim 1, further comprising:
a colored image displaying device for displaying an image assigned with color with reference to the difference.

9. The image inspection apparatus according to claim 1, further comprising:
a histogram displaying device for quantitative displaying of the threshold value in a histogram for the difference.

10. The image inspection apparatus according to claim 1, wherein
the characteristic amount is at least one of sign information related to the sign of the difference, a total of the difference, a maximum value of the difference, an average value of the difference, or a reference deviation of the difference.

11. The image inspection apparatus according to claim 1, wherein
the characteristic amount calculating device is adapted to calculate the characteristic amount in the form of two or more of any of sign information related to the sign of the difference, a total of the difference, a maximum value of the difference, an average value of the difference, or a reference deviation of the difference; and
the defect discriminating device is adapted to discriminate a defect in the aggregate body of pixels based on a discrimination reference value combining two or more of the calculated characteristic amounts.

12. The image inspection apparatus according to claim 1, wherein
the defect discriminating device is adapted to discriminate a defect in the aggregate body of pixels based on a discrimination reference value that combines the characteristic amount and the surface area of the specified aggregate body of pixels.

13. An image inspection method comprising:
an imaging process for acquiring a multi-valued image of an inspection object region;
a reference intensity value calculating process for calculating a reference intensity value based on intensity information for the acquired multi-valued image;
a difference calculating process for calculating a difference for each pixel between the intensity value for each pixel of the multi-valued image and the calculated reference intensity value;
a threshold value storing process for setting and storing a threshold value relative to the reference intensity value to track and change in response to a change in the reference intensity value;
a labeling process for extracting a plurality of pixels that have a calculated difference that is larger than the threshold value, and specifying an aggregate body of pixels based on the connectivity of the intensity value of the plurality of extracted pixels;
a characteristic amount calculating process for calculating a characteristic amount using the difference in relation to an aggregate body of pixels specified in the labeling process; and
a defect discriminating process for discriminating a defect in a specified aggregate body of pixels based on the calculated characteristic amount.

14. A computer program causing a computer to execute
imaging processing for acquiring a multi-valued image of an inspection object region;
reference intensity value calculating processing for calculating a reference intensity value based on intensity information for the acquired multi-valued image;
difference calculating processing for calculating a difference for each pixel between the intensity value for each pixel of the multi-valued image and the calculated reference intensity value;
threshold value storing processing for setting and storing a threshold value relative to the reference intensity value to track and change in response to a change in the reference intensity value;
labeling processing for extracting a plurality of pixels that have a calculated difference that is larger than the threshold value, and specifying an aggregate body of pixels based on the connectivity of the intensity value of the plurality of extracted pixels;
characteristic amount calculating processing for calculating a characteristic amount using the difference in relation to an aggregate body of pixels specified in the labeling process; and
defect discriminating processing for discriminating a defect in a specified aggregate body of pixels based on the calculated characteristic amount.
